(19) United States
(12) Patent Application Publication
(10) Pub. No.: US 2022/0117438 A1
(43) Pub. Date: Apr. 21, 2022

(54) SYSTEMS, METHODS, AND DEVICES FOR ESTIMATING REMAINING COOKING TIME

(71) Applicant: Mastrad, Paris (FR)

(72) Inventors: Mathieu Lion, Paris (FR); Samuel Puong, Paris (FR)

(21) Appl. No.: 17/073,816

(22) Filed: Oct. 19, 2020

(51) Int. Cl. A47J 36/32; G04F 13/00; G01K 13/00; G01K 1/02

(52) U.S. Cl. CPC A47J 36/32; G04F 13/00; A47J 2202/00; G01K 1/026; G01K 1/024; G01K 13/00

(57) ABSTRACT

A system for estimating remaining cooking time obtains a target temperature, obtains an ambient temperature value, and receives a plurality of inner temperature values based on temperature data obtained by a relevant inner temperature sensor at a plurality of different timepoints. The system also calculates a plurality of natural logarithm values including, for each particular inner temperature value of the plurality of inner temperature values, a natural logarithm of a difference between the ambient temperature value and the particular inner temperature value. The system also determines a linear regression line that models a relationship between the plurality of natural logarithm values and the plurality of different timepoints, obtains a slope value and an interception value based on the linear regression line, and determines a remaining time based on the interception value, the slope value, and a natural logarithm of a difference between the ambient temperature value and the target temperature.

### BACKGROUND

Many food products, such as meat products, are often cooked prior to human consumption. Cooking food products accomplishes various objectives, such as improving taste and/or eliminating foodborne pathogens that may be present in food products (e.g., especially meat products). Food products may be cooked in various ways using various devices. Many cooking devices, such as ovens, grills, and/or others, comprise an enclosure and a heat or radiation source configured to heat food products positioned within the enclosure (e.g., via conventional or forced-air heat convection, electromagnetic wave propagation, etc.).

Users often desire to cook food according to predefined specifications in order to achieve one or more particular results. By way of example, the United States Department of Agriculture recommends cooking whole cuts of pork, beef, veal, and lamb to an internal temperature of 145° F. (about 63° C.) with a rest time of three minutes prior to carving or consuming in order to destroy harmful bacteria that may be present in the meat products.

In addition to eliminating foodborne pathogens, users may desire to cook food in order to give the food desired characteristics in preparation for human consumption. For example, beef products (and other meat products) may be cooked according to different cooking gradations to achieve different meat characteristics such as color, juiciness, and internal temperature when cooked. Cooking gradations may vary based on region and/or cuisine. In some United States cuisines, for beef steaks and roasts, extra-rare doneness may be characterized as providing a very red center with an internal temperature range of about 115-125° F. (about 46-49° C.), rare doneness may be characterized as providing a red center and as soft with an internal temperature range of about 125-130° F. (about 52-55° C.), medium rare doneness may be characterized as providing a warm red center and as firmer with an internal temperature range of about 130-140° F. (about 55-60° C.), medium doneness may be characterized as providing a pink center and as firm with an internal temperature range of about 140-150° F. (about 60-65° C.), medium well doneness may be characterized as providing a small amount of pink in the center with an internal temperature range of about 150-155° F. (about 65-69° C.), and well done doneness may be characterized as being gray-brown throughout and as firm with an internal temperature that is about 160° F. or greater (about 71° C. or greater).

The cooking of food products to achieve desired results (e.g., to reach a desired internal temperature to eliminate foodborne pathogens or achieve a desired level of doneness) is often regarded as a delicate operation. Many users err in achieving desired cooking results even while utilizing conventional cooking thermometers and/or other devices configured to detect internal temperature of a food product during the cooking process. For example, users often have difficulty positioning a temperature sensor to detect an innermost core temperature of a food product, causing temperature readings from the temperature sensor to fail to accurately represent the internal temperature of the food product. Such inaccuracies can cause users to overcook or undercook their food products by reliance on inaccurate temperature readings.

Furthermore, conventional cooking thermometers fail to provide users with an accurate estimation of cooking time remaining before a food product will reach desired internal temperature. In many instances, users repeatedly check on cooking thermometer temperature readings throughout the cooking process, which may prevent users from engaging in other activities during the cooking process (e.g., entertaining guests) and may cause users to repeatedly open a cooking enclosure to check the temperature readings.

For at least the foregoing reasons, there is an ongoing need and desire for improved systems, methods, and devices for estimating remaining cooking time.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Implementations of the present disclosure extend to systems, methods, and devices for estimating remaining cooking time.

Some embodiments include computer-executable instructions that are executable by one or more processors of a system to configure the system to perform various acts associated with estimating a remaining cooking time. In some implementations, a system is configurable to obtain a target temperature, obtain an ambient temperature value based on temperature data obtained by an ambient temperature sensor, and receive a plurality of inner temperature values based on temperature data obtained by a relevant inner temperature sensor at a plurality of different timepoints. The system is also configurable to calculate a plurality of natural logarithm values including, for each particular inner temperature value of the plurality of inner temperature values, a natural logarithm of a difference between the ambient temperature value and the particular inner temperature value.

The system is also configurable to determine a linear regression line that models a relationship between the plurality of natural logarithm values and the plurality of different timepoints, obtain a slope value and an interception value based on the linear regression line, and determine a remaining time indicating an estimated time period for an inner temperature of the relevant inner temperature sensor to reach the target temperature. The remaining time may be based on the lowest temperature value to reach the target temperature (e.g., where the relevant inner temperature sensor is one of multiple inner temperature sensors), and the remaining time may be recomputed or estimated based on Newton's law of cooling/heating, the slope value, and a natural logarithm of a difference between the ambient temperature value and the target temperature.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1A illustrates a side view of an example of a temperature probe that includes a first temperature sensor, a second temperature sensor, and a third temperature sensor;

FIG. 1B illustrates a cross-sectional side view of the temperature probe of FIG. 1A;

FIG. 2 illustrates an example system for estimating a remaining cooking time for an internal temperature sensor to reach a target temperature;

FIG. 3 illustrates an example graphical representation of receiving temperature data from multiple temperature sensors and defining a temperature sensor as a relevant temperature sensor;

FIG. 4 illustrates an example graphical representation of obtaining inner temperature values from a relevant temperature sensor for a first time period;

FIG. 5 illustrates an example graphical representation of obtaining an ambient temperature within a cooking enclosure for the first time period;

FIG. 6 illustrates an example graphical representation of obtaining inner temperature values from a relevant temperature sensor for a second time period;

FIG. 7 illustrates an example graphical representation of obtaining an ambient temperature within a cooking enclosure for the second time period;

FIG. 8 illustrates an example graphical representation of obtaining inner temperature values from a relevant temperature sensor for a third time period;

FIG. 9 illustrates an example graphical representation of obtaining an ambient temperature within a cooking enclosure for the third time period;

FIG. 10 illustrates an example graphical representation of determining a linear regression line that models a relationship between timepoints of the third time period and natural logarithm values of differences between the ambient temperature for the third time period and the various inner temperature values for the third time period;

FIG. 11 illustrates an example graphical representation of determining a remaining time indicating an estimated time period for an inner temperature of the relevant temperature sensor to reach the target temperature; and

FIG. 12 illustrates an example flow diagram depicting a method for estimating an amount of time remaining for a temperature sensor to reach a target temperature.

### DETAILED DESCRIPTION

Implementations of the present disclosure extend to systems, methods, and devices for estimating remaining cooking time. For example, a system, method, or device for estimating remaining cooking time may be associated with the performance of, or being configurable to perform, various acts.

In some implementations, the acts include obtaining a target temperature, obtaining an ambient temperature value based on temperature data obtained by an ambient temperature sensor, and receiving a plurality of inner temperature values based on temperature data obtained by a relevant inner temperature sensor at a plurality of different timepoints. The acts may also include calculating a plurality of natural logarithm values including, for each particular inner temperature value of the plurality of inner temperature values, a natural logarithm of a difference between the ambient temperature value and the particular inner temperature value.

The acts may also include determining a linear regression line that models a relationship between the plurality of natural logarithm values and the plurality of different timepoints, obtaining a slope value and an interception value based on the linear regression line, and determining a remaining time indicating an estimated time period for an inner temperature of the relevant inner temperature sensor to reach the target temperature. The remaining time is based on the interception value, the slope value, and a natural logarithm of a difference between the ambient temperature value and the target temperature.

Those skilled in the art will recognize, in view of the present disclosure, that at least some of the disclosed embodiments may be implemented to address various shortcomings associated with conventional systems, methods, and devices for detecting temperature values, in particular for estimating remaining cooking time.

For example, at least some implementations of the present disclosure are configured to determine a relevant temperature sensor from a plurality of temperature sensors of a single temperature probe that is inserted into a food product (e.g., a meat product). The temperature probe may include a temperature sensor on a tip thereof and a temperature sensor on a middle portion thereof. The relevant temperature sensor may comprise a temperature sensor that is closest to an innermost center or core of a food product (relative to the other temperature sensor(s)). Temperature values detected by the relevant temperature sensor may therefore provide an accurate representation of the inner temperature of a food product.

In this regard, at least some implementations of the present disclosure are configured to at least partially compensate for situations where a user fails to accurately position a temperature probe within a food product with a tip of the temperature probe arranged at or near the inner core of the food product. For example, a user may position a temperature probe within a food product such that a temperature sensor at the tip of the temperature probe extends past the inner core of the food product (relative to the initial entry point). In some instances, a middle temperature sensor at a middle portion of the temperature probe may provide a more accurate representation of the inner temperature of the food product. Implementations of the present disclosure may intelligently determine whether to define the tip temperature sensor or the middle temperature sensor as the relevant sensor.

Furthermore, at least some implementations of the present disclosure are configured to determine an estimated cooking time based on temperature values obtained by the relevant temperature sensor (as well as other data) in an improved, accurate manner. Providing an accurate estimate of remaining cooking time may allow users to confidently engage in other activities during cooking processes (e.g., entertaining guests) and may allow users to check internal temperature less frequently.

As used herein, “meat” and “meat products” refer to the flesh of any animal used as food, including, but not limited to, beef, pork, poultry or other bird meat, sheep meat, fish and other seafood, buffalo, venison, caribou, crustaceans, mollusks, kangaroo, reptile, meats, and/or others. Although the present disclosure focuses, in at least some respects, on the heating of meat and meat products, it will be appreciated, in view of the present disclosure, that any food or other product/material (e.g., vegetables, soups, pastries, and/or others) may be cooked or heated in accordance with the principles disclosed herein.

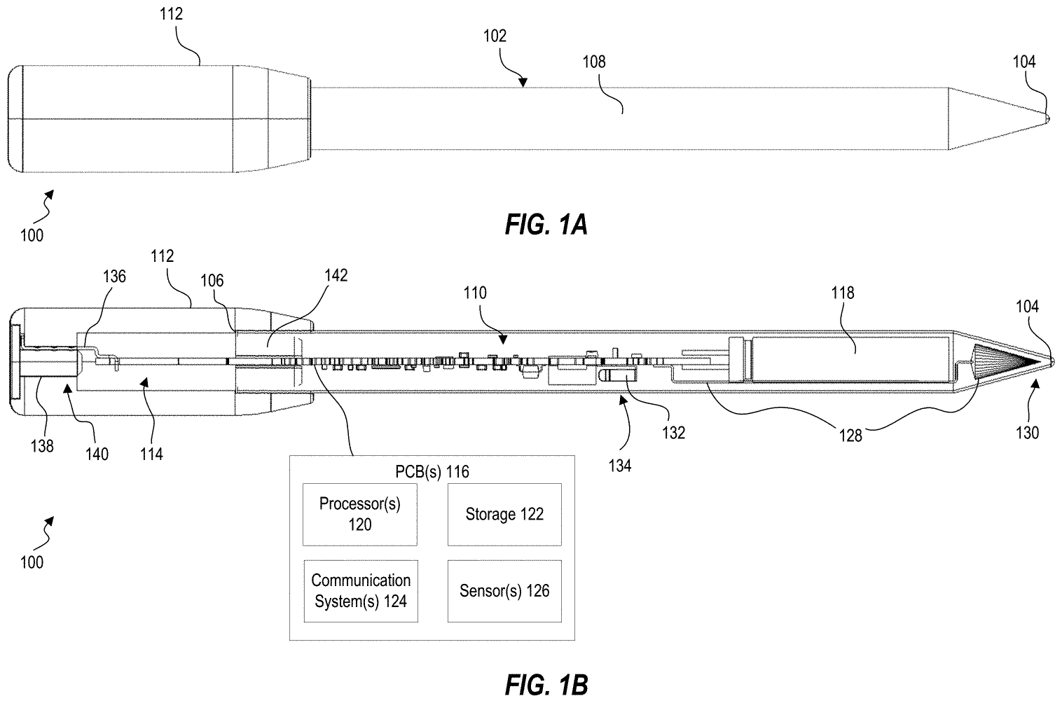

Having described some of the various high-level features and benefits of the disclosed embodiments, attention will now be directed to FIGS. 1A through 12. These Figures illustrate various conceptual representations, architectures, methods, and/or supporting illustrations related to the disclosed embodiments.

FIG. 1A illustrates a side view of an example of a temperature probe 100, and FIG. 1B illustrates a cross-sectional side view of the temperature probe 100. FIGS. 1A and 1B illustrate that the temperature probe 100 includes a shaft 102 that extends between a distal tip 104 and a proximal end 106. The distal tip 104 comprises a pointed tip of the shaft and is shaped for penetrating a food product (e.g., a meat product) to facilitate positioning of the shaft 102 within an interior of the food product. The shaft 102 may comprise any suitable material, such as stainless steel.

As used herein, the term “distal” refers to a direction pointing toward a food product targeted for penetration by the temperature probe 100 to arrange the shaft 102 within the interior of the food product, while the term “proximal” refers to the opposite direction directed away from the food product targeted for penetration by the temperature probe 100. Thus, for example, the distal tip 104 of the shaft 102 is intended to point towards or facilitate penetration into a food product to advance the shaft 102 into the food product, whereas the proximal end 106 of the shaft is an opposite end of the shaft that is intended to point away from a food product prior to and during penetration into the food product.

FIGS. 1A and 1B illustrate that the shaft 102 is at least partially formed from a lateral sidewall 108 that forms a cavity 110 within the shaft 102 between the distal tip 104 and the proximal end 106. Furthermore, FIGS. 1A and 1B show that the temperature probe 100 includes a ceramic cap 112 that is configured to fit circumferentially about the shaft 102 and over the proximal end 106 of the shaft 102. In the embodiment illustrated in FIGS. 1A and 1B, the ceramic cap 112 is configured to secure over the proximal end 106 of the shaft 102 via a friction fit, however other attachment mechanisms are within the scope of this disclosure (e.g., a threaded connection). The ceramic cap 112 also forms a cavity 114 within the ceramic cap 112.

FIG. 1B illustrates printed circuit board(s) (PCB(s)) 116 disposed within the cavity 110 of the shaft 102 and within the cavity 114 of the ceramic cap 112. The PCB(s) 116 may comprise and/or be in communication with various components to control the functioning of the temperature probe 100. For example, the PCB(s) 116 may be in communication with a battery 118 to provide power to the various components of the temperature probe 100. Furthermore, the PCB(s) 116 may comprise or be in communication with processor(s) 120, storage 122, communication system(s) 124, and/or sensor(s) 126.

The processor(s) 120 may comprise one or more sets of electronic circuitry that include any number of logic units, registers, and/or control units to facilitate the execution of computer-readable instructions (e.g., instructions that form a computer program). Such computer-readable instructions may be stored within the storage 122, which may comprise physical system memory, which may be volatile, non-volatile, or some combination thereof. Additional details related to processors (e.g., processor(s) 120) and computer storage media (e.g., storage 122) will be provided hereinafter.

The communication system(s) 124 may enable the temperature probe 100 to communicate wirelessly (and/or in a wired manner) with external systems and/or devices through any suitable communication channel(s), such as, by way of non-limiting example, Bluetooth, ultra-wideband, WLAN, LoRaWAN, infrared communication, and/or others. As will be described in more detail hereinafter, the communication system(s) 124 may comprise a wireless transmitter configured to emit signals communicating temperature values sensed by the temperature probe 100.

The sensor(s) 126 may comprise one or more temperature sensors that is/are configured to obtain temperature measurements/values associated with various portions of the temperature probe 100. The sensor(s) 126 configured for measuring temperature may take on any suitable form, such as thermistor sensors, resistance temperature detectors, thermocouples, and/or others. One will appreciate, in view of the present disclosure, that the sensor(s) 126 may comprise or rely on various components that are coupled to the PCB(s) 116 to obtain temperature measurements/values.

For example, the PCB(s) 116 may be connected to a first conductive element 128 that is in communication with one or more of the sensor(s) 126 and that extends from the PCB(s) 116 within the cavity 110 toward an interior of the distal tip 104 of the shaft 102 of the temperature probe 100. The sensor(s) 126 and the first conductive element 128 may form a first temperature sensor 130 configured to sense a temperature associated with the distal tip 104 of the shaft 102. In some instances, thermal paste, or another thermally conductive material, forms a thermally conductive path between the first conductive element 128 and the interior portion of the distal tip 104 to allow the first temperature sensor 130 to obtain temperature measurements that more accurately reflect the temperature of the distal tip 104.

In some instances, at least a portion of the first conductive element 128 includes or forms a flex PCB element with a thinness that allows the first conductive element 128 to extend through the narrow space between the battery 118 and the inner sidewall of the shaft 108 in order to reach the main PCB(s) 116. In some instances, the flex PCT portion of the first conductive element 128 comprises a thickness within a range of about 0.25 mm or lower (e.g., about 0.2 mm).

When the temperature probe 100 is inserted into a food product as described hereinabove, the first temperature sensor 130 may be operable to sense an inner temperature of the food product. As will be described hereinafter, the first temperature sensor 130 may obtain inner temperature values that are usable, in combination with other data, to determine an estimated remaining cooking time.

Furthermore, the PCB(s) 116 may be connected to a second conductive element 132 that is in communication with one or more of the sensor(s) 126 and that extends from the PCB(s) 116 within the cavity 110 toward an interior of a middle portion of the shaft 102 between the distal tip 104 and the proximal end 106 thereof. The sensor(s) 126 and the second conductive element 132 may form a second temperature sensor 134 configured to sense a temperature associated with the middle portion of the shaft 102. In some instances, a thermal pad, or another thermally conductive material, forms a thermally conductive path between the second conductive element 132 and the interior of the middle portion of the shaft 102 between the distal tip 104 and the proximal end 106 to allow the second temperature sensor 134 to obtain temperature measurements that more accurately reflect the temperature of the middle portion of the shaft 102. In some instances, utilizing a thermal pad rather than thermal paste or another thermally conductive product may prevent unintended electrical contact between the PCB(s) 116 and the shaft 102.

Similar to the first temperature sensor 130, when the temperature probe 100 is inserted into a food product as described hereinabove, the second temperature sensor 134 may be operable to sense an inner temperature of the food product. For example, in some instances, when a user penetrates a food product with the distal tip 104 and advances the shaft 102 into the food product, both the first temperature sensor 130 and the second temperature sensor 134 are both configured to sense internal temperature of the food product. As will be described hereinafter, the second temperature sensor 134 may obtain inner temperature values that are usable, in combination with other data, to determine an estimated remaining cooking time.

Additionally, in some instances, the PCB(s) 116 may be connected to a third conductive element 136 that is in communication with one or more of the sensor(s) 126 and that extends from the PCB(s) 116 within the cavity 114 of the ceramic cap 112 toward a conductive pin 138 associated with the ceramic cap 112. The sensor(s) 126, the third conductive element 136, and the conductive pin 138 may form a third temperature sensor 140 configured to sense a temperature associated with the ceramic cap 112 of the temperature probe 100.

In some instances, the temperature associated with the ceramic cap 112 is at least partially representative of a temperature of a cooking environment that surrounds the temperature probe 100, such as a temperature within a cooking enclosure of an oven, grill, or other cooking device. For example, after the shaft 102 of the temperature probe 100 is inserted into a food product, the ceramic cap 112 may remain disposed outside of the food product, enabling the third temperature sensor 140 to sense a temperature within the cooking environment outside of the ceramic cap 112. As will be described hereinafter, the third temperature sensor 140 may obtain ambient temperature data that is usable, in combination with other data, to determine an estimated remaining cooking time.

The third temperature sensor 140 may be configured to sense an ambient temperature of a cooking environment surrounding the ceramic cap 112 of the temperature probe 100 directly or indirectly. In some instances, the temperature sensor for sensing ambient cooking environment temperature is separate from the temperature probe 100.

FIG. 1B illustrates that, in some implementations, the temperature probe 100 includes a silicone stopper 142 positioned within the shaft 102 surrounding a portion of the PCB(s) 116 and intervening between the cavity 114 of the ceramic cap 112 and the cavity 110 of the shaft 102. In some instances, the silicone stopper 142 operates to insulate components within the interior cavity 110 (e.g., processor(s) 120, storage 122, etc.) from heat that transfers from the ambient cooking environment to the ceramic cap 112.

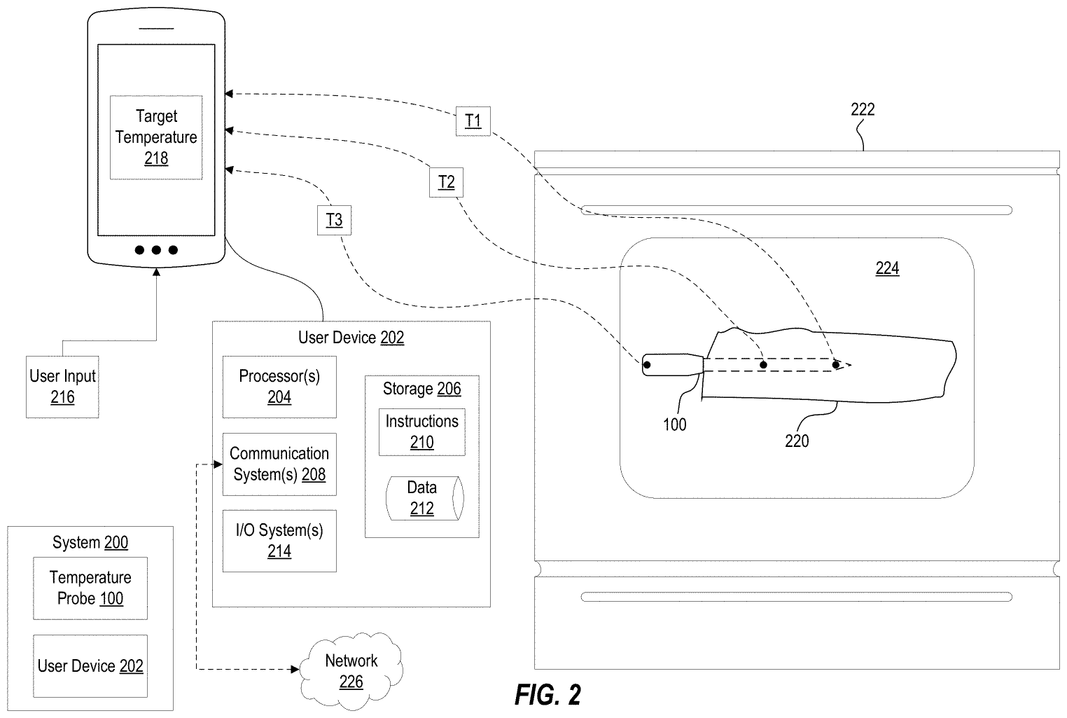

FIG. 2 illustrates an example system 200 for estimating a remaining cooking time, which may include a temperature probe 100 and a user device 202. The temperature probe 100 may be as described hereinabove with reference to FIGS. 1A and 1B. The user device 202 may comprise processor(s) 204, storage 206, communication system(s) 208, and input/output (I/O) system(s) 214. The processor(s) 204 and the storage 206 may of the user device 202 may correspond in essence to the processor(s) 120 and the storage 122 associated with the PCB(s) 116 of the temperature probe 100 described hereinabove.

For instance, as will be described in more detail, the processor(s) 204 may be configured to executed instructions 210 stored within storage 206 to perform certain actions associated with determining a remaining cooking time. The actions may rely at least in part on data 212 stored on storage 206 in a volatile or non-volatile manner. The actions may also rely at least in part on communication system(s) 208 for receiving data from the temperature probe 100 and/or I/O system(s) 214 for receiving user input 216 from a user. I/O system(s) 214 may include any type of input or output device such as touch screens, displays, a mouse, a keyboard, a controller, without limitation.

By way of example, the user device 202 may receive user input 216 that indicates a target temperature 218, which may represent a desired core/internal temperature for cooking a food product 220. In some implementations, the user input 216 indicates a type of food product (e.g., beef, pork, poultry, etc.) and/or a desired doneness for the food product (e.g., rare, medium rare, medium, medium well, well done, etc.). The user device 202 may then identify the target temperature 218 based on the user input 216 by accessing a data structure (e.g., from data 212 of storage 206) that correlates ideal temperature values to food product type (e.g., based on desired levels of doneness, which may depend on region). In some instances, a data structure (e.g., from data 212 of storage 206, or from another source) may comprise food composition properties that may be affect thermodynamic properties of the food product (meat type/density, fat content, bones, etc.) The user device may additionally or alternatively rely on other inputs (whether user-provided, obtained from a data structure, or otherwise) to determine a target temperature, such as type, brand, and/or model of cooking device (e.g., oven, grill, etc.), humidity/elevation, and/or others.

A user device 202 may access a data structure that includes cooking temperature values correlated to food product types, food composition properties, and/or other data in a variety of ways. For example, in some instances, at least a portion of a data structure is stored (whether in a volatile manner or not) as data 212 on the storage 206 of the user device. Additionally, or alternatively, such a data structure may be at least partially accessed or obtained via a cloud or other network 226 and/or from a remote device (e.g., as depicted in FIG. 2 by the communication system(s) 208 connected to the network 226 by a dashed line).

In other implementations, the user input 216 directly states/selects a target temperature (TT) 218 representing a desired core/internal temperature for cooking the food product 220.

Before, after, or contemporaneous with determining a target temperature 218, a user may insert the temperature probe 100 into the food product 220 as described hereinabove. The user may then place the food product 220 with inserted temperature probe 100 into/onto a cooking device 222. The user may also turn on the cooking device to begin heating the food product 220 and the temperature probe 100. Although FIG. 2 depicts the cooking device 222 as an oven, other types of cooking devices are within the scope of this disclosure.

As noted above, the temperature probe 100 may comprise communication system(s) 124 that include one or more wireless transmitters configured to emit signals communicating temperature values sensed by the temperature probe 100. The temperature values may be detected by the various temperature sensors of the temperature probe 100, such as the first temperature sensor 130, the second temperature sensor 134, and/or the third temperature sensor 140 described hereinabove.

FIG. 2 illustrates the user device 202 wirelessly receiving temperature data obtained by the various sensors of the temperature probe 100 (e.g., via communication system(s) 208). For example, FIG. 2 shows the user device 202 receiving temperature values T1 obtained by the first temperature sensor 130, temperature values T2 obtained by the second temperature sensor 134, and temperature values T3 obtained by the third temperature sensor 140. When the temperature probe 100 is inserted into the food product 220 and positioned within the active cooking device 222, temperature values T1 and T2 may indicate an interior or inner temperature of the food product, whereas temperature values T3 may indicate a temperature of the ambient cooking environment 224 within the cooking device 222. In this way, the first temperature sensor 130 and the second temperature sensor 134 may be regarded as inner temperature sensors, and the third temperature sensor 140 may be regarded as an ambient temperature sensor.

As noted hereinabove, users often find difficulty positioning a temperature probe within a food product in a manner that positions the tip of the temperature probe at or near an innermost core of the food product. This is particularly true where food products are short in length such that as a shaft of a temperature probe is fully inserted into a food product, the tip of the temperature probe advances past the innermost core of the food product. Accordingly, in at least some implementations, the temperature probe 100 is configured to ameliorate this issue by including a first temperature sensor 130 configured to sense temperature for the distal tip 104 of the shaft 102 and a second temperature sensor 134 configured to sense temperature for a middle portion of the shaft 102. Upon insertion into a food product, either the first temperature sensor 130 or the second temperature sensor 134 will be closer to the innermost core of the food product, and systems of the present disclosure may be configured to intelligently identify which temperature sensor to utilize for inner temperature values of the food product.

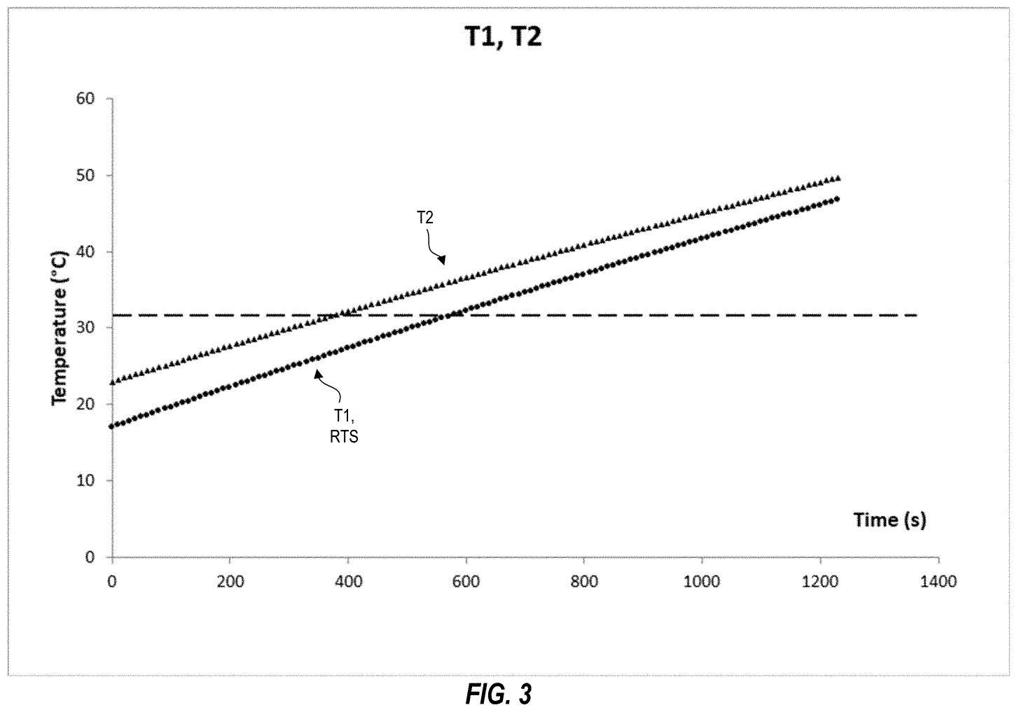

FIG. 2 shows an implementation where the temperature probe 100 is inserted into the food product 220 such that the first temperature sensor 130 (providing temperature values T1) is positioned nearer to the innermost core of the food product 220 than the second temperature sensor 134 (providing temperature values T2). FIG. 3 illustrates an example graphical representation of the temperature values T1 and T2 received by the user device 202 from the temperature probe 100. FIG. 3 depicts the temperature values T1 over time with circles and depicts the temperature values T2 over time with triangles.

Based on the received temperature values T1 and T2, the system 200 may define the first temperature sensor 130 or the second temperature sensor 134 as a relevant temperature sensor (RTS) that most accurately represents the temperature of the innermost core of the food product 220. In some instances, the innermost core is a portion of the interior of the food product 220 that is furthest from the exterior of the food product and therefore furthest from ambient cooking environment 224 surrounding the food product 220. Accordingly, in some instances, the temperature sensor that is positioned nearest to the innermost core will provide lower temperature values than the other temperature sensor(s) of the temperature probe 100.

Thus, in some implementations, the system 200 detects a triggering condition and, in response to detecting the triggering condition, defines a relevant temperature sensor based as the temperature sensor that is associated with the lowest temperature value/reading relative to the other temperature sensors.

As is evident from FIG. 3, the temperature values T1 are lower than the temperature values T2 for the time period represented in FIG. 3. This indicates that the first temperature sensor 130 (providing temperature values T1 associated with the distal tip 104 of the temperature probe 100) is arranged nearer to the innermost core of the food product 220 than the second temperature sensor 134. Thus, the system 200 may define the first temperature sensor 130 as the relevant temperature sensor (RTS, as indicated in FIG. 3) in response to a triggering condition.

A system 200 may employ various triggering conditions for defining a relevant temperature sensor. For example, FIG. 3 illustrates a threshold temperature of 32° C. as a dashed horizontal line on the graph represented in FIG. 3. In some implementations, the triggering condition for defining a relevant temperature sensor is based on one or more of the inner temperature sensors (first temperature sensors 130 and second temperature sensor 134) providing temperature readings/values that satisfy the threshold temperature of 32° C. By way of example, in response to determining that both the temperature values T1 and the temperature values T2 satisfy the threshold temperature of 32° C., the system 200 may assess that a current temperature value T1 is lower than a current temperature value T2 and therefore define the first temperature sensor 130 (providing the temperature values T1) as the relevant temperature sensor (RTS).

In other instances, the system defines the relevant temperature sensor in response to determining that at least one, a half, or a majority of the temperature sensors provide temperature values that satisfy a predetermined threshold temperature value. In yet other instances, the system defines the relevant temperature sensor in response to determining that the average or other measure of center of the temperature values provided by the various temperature sensors satisfies a threshold temperature value. In still other instances, the system defines the relevant temperature sensor in response to determining that a predetermined time period has elapsed after initiating the cooking process. Although the present disclosure focuses, in at least some respects, on a temperature probe 100 that includes two inner temperature sensors (i.e., first temperature sensor 130 and second temperature sensor 134), a temperature probe 100 may comprise any number of inner temperature sensors within the scope of the present disclosure.

Upon defining a relevant temperature sensor (RTS) (or in response to another triggering condition), the system 200 may proceed to gather data for determining a remaining cooking time for the food product 220. The remaining cooking time may comprise an estimated remaining time period for the relevant temperature sensor to reach the target temperature 218 described hereinabove with reference to FIG. 2.

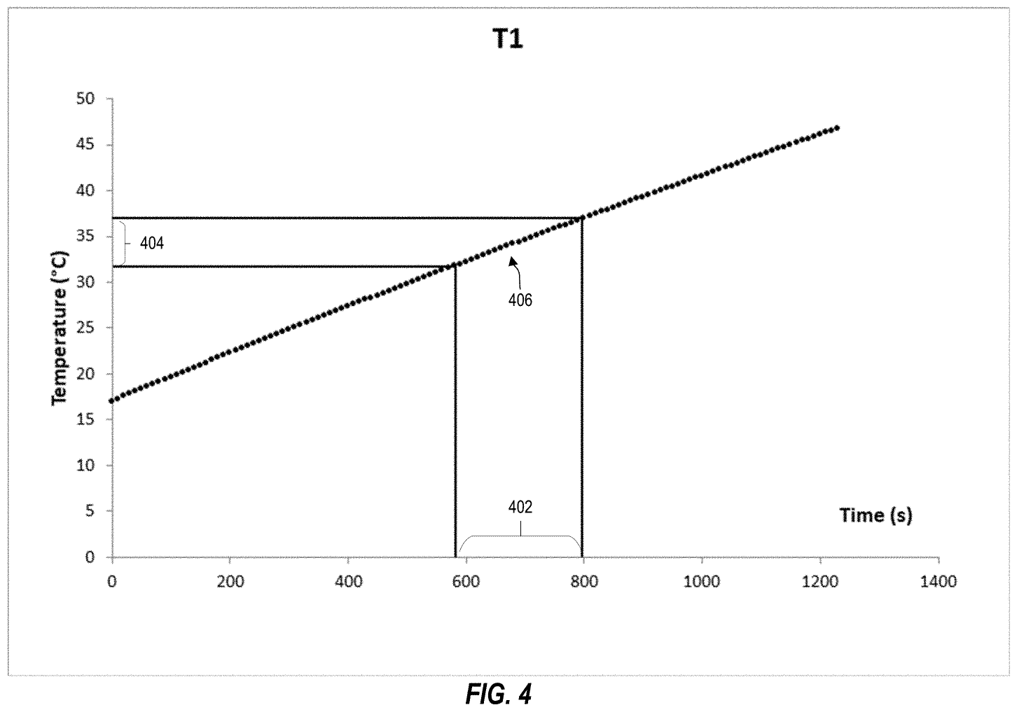

FIG. 4 illustrates an example graphical representation of temperature values T1 obtained by the first temperature sensor 130, which the system 200 has designated as the relevant temperature sensor (RTS). FIG. 4 highlights temperature values T1 associated with a particular plurality of timepoints of a time period 402. The time period 402 may be associated with a particular temperature range 404, and the temperature range 404 may be defined according to a predefined temperature step size or predefined temperature difference. For example, after designating the first temperature sensor 130 as the relevant temperature sensor based on the first temperature sensor 130 being the last inner temperature sensor to provide a temperature reading/value 32° C. (e.g., as illustrated hereinabove with reference to FIG. 3), the system 200 may utilize 32° C. as an initial temperature value and define a final temperature value at a predetermined temperature offset or difference from the initial temperature value.

FIG. 4 demonstrates an example in which the initial temperature value is 32° C., the predetermined temperature difference is 5° C., and the final temperature value is 37° C., providing the particular temperature range 404 of 32° C. to 37° C. FIG. 4 illustrates a subset 406 of temperature values T1 that are within the particular temperature range 404. The temperature values T1 of the subset 406 are obtained by the first temperature sensor 130 at timepoints of the plurality of timepoints within the time period 402.

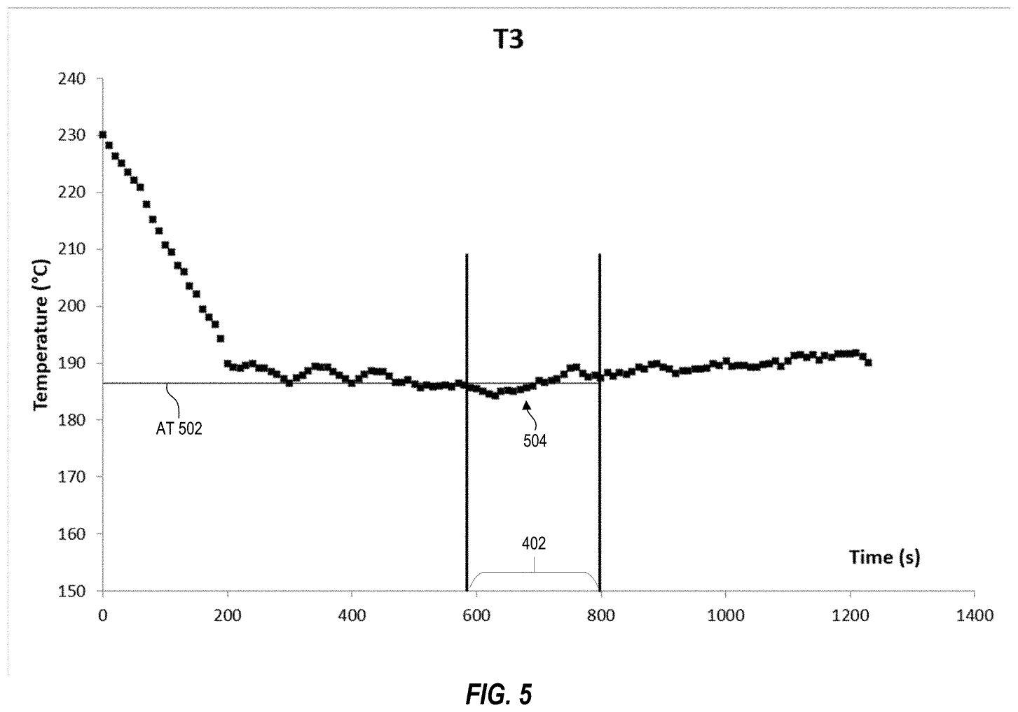

FIG. 5 illustrates an example graphical representation of obtaining an ambient temperature (AT) 502 for association with the subset 406 of temperature values T1. For example, FIG. 5 illustrates a subset 504 of temperature values T3 obtained by the third temperature sensor 140, which are representative of the temperature within the ambient cooking environment 224 surrounding the food product 220 from FIG. 2. The temperature values T3 of the subset 504 are obtained by the third temperature sensor 140 at timepoints within the time period 402 that correspond to the timepoints at which the temperature values T1 of the subset 406 are obtained by the first temperature sensor 130. The system 200 may calculate the ambient temperature 502 as an average temperature value of the subset 504 of temperature values T3, and the system 200 may associate the ambient temperature 502 with the subset 406 of inner temperature values T1 (and the timepoints within the time period 402 at which the temperature values T1 of the subset 406 are obtained).

As will be described hereinafter, a system 200 may utilize ambient temperature values (e.g., AT 502) and inner temperature values (e.g., temperature values T1 of subset 406) obtained at a plurality of timepoints (e.g., within time period 402) to determine an estimated remaining cooking time. Because physical properties of a food product 220 often change during the cooking process (e.g., water vaporization, protein, and/or fat content), an estimated remaining cooking time may underestimate the true remaining time for the inner temperature sensor (e.g., temperature sensor 130) to reach the target temperature 218 (in particular for early estimates). Thus, in some implementations, a system may determine updated estimated remaining cooking times using ambient temperature values and inner temperature values obtained based on timepoints of subsequent time periods.

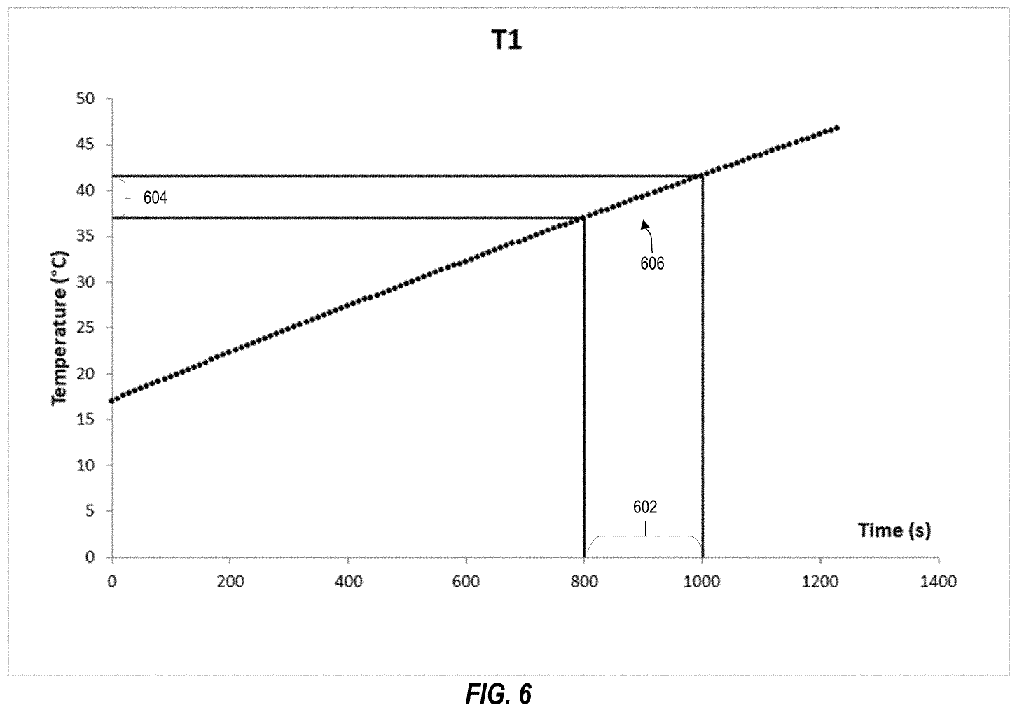

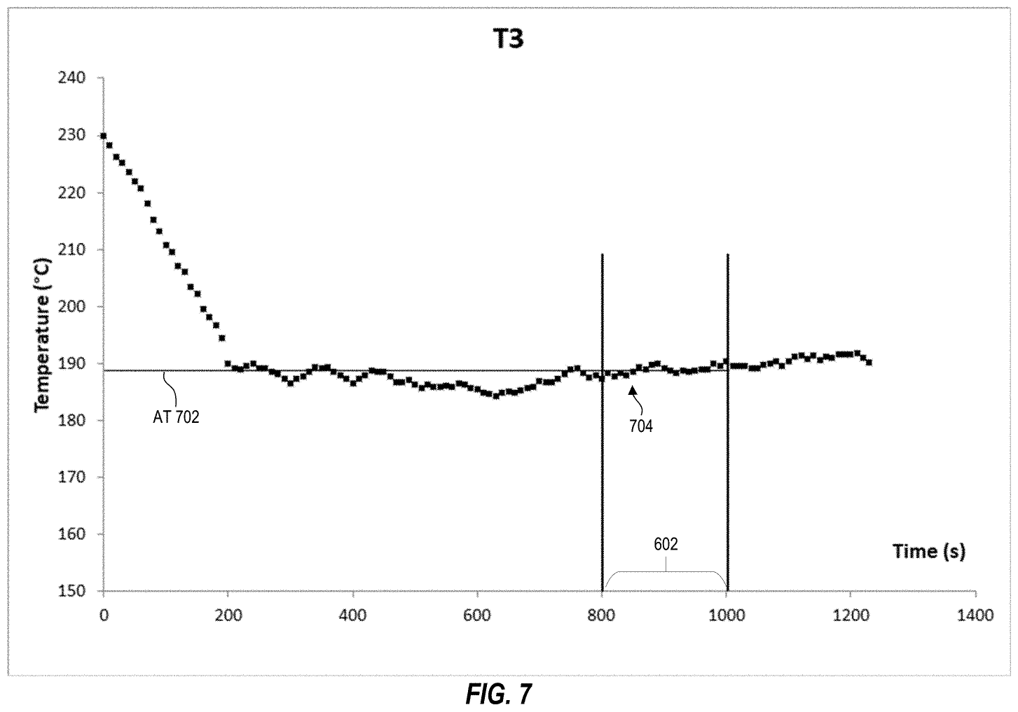

For example, FIG. 6 illustrates a subset 606 of temperature values T1 obtained by the first temperature sensor 130 within a temperature range 604 of 37° C. to 42° C. at timepoints within a time period 602 that is temporally subsequent to the time period 402 from FIGS. 4 and 5. FIG. 7 illustrates an ambient temperature 702 calculated based on a subset 704 of temperature values T3 obtained by the third temperature sensor 140 at timepoints within the time period 602. The system 200 may calculate an updated estimated cooking time using these components.

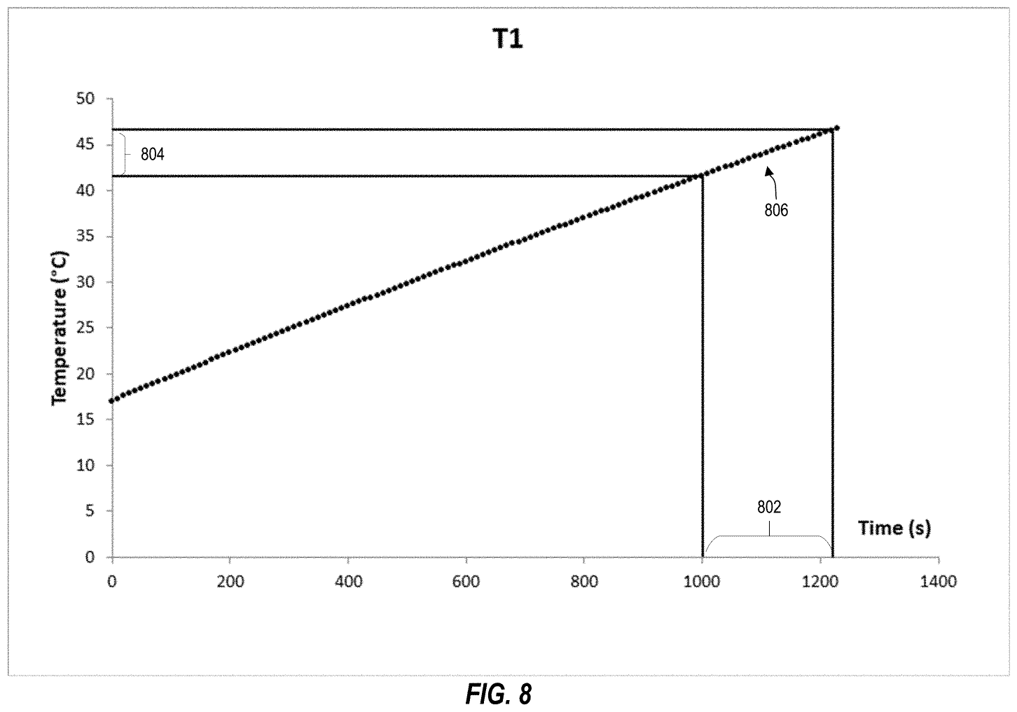

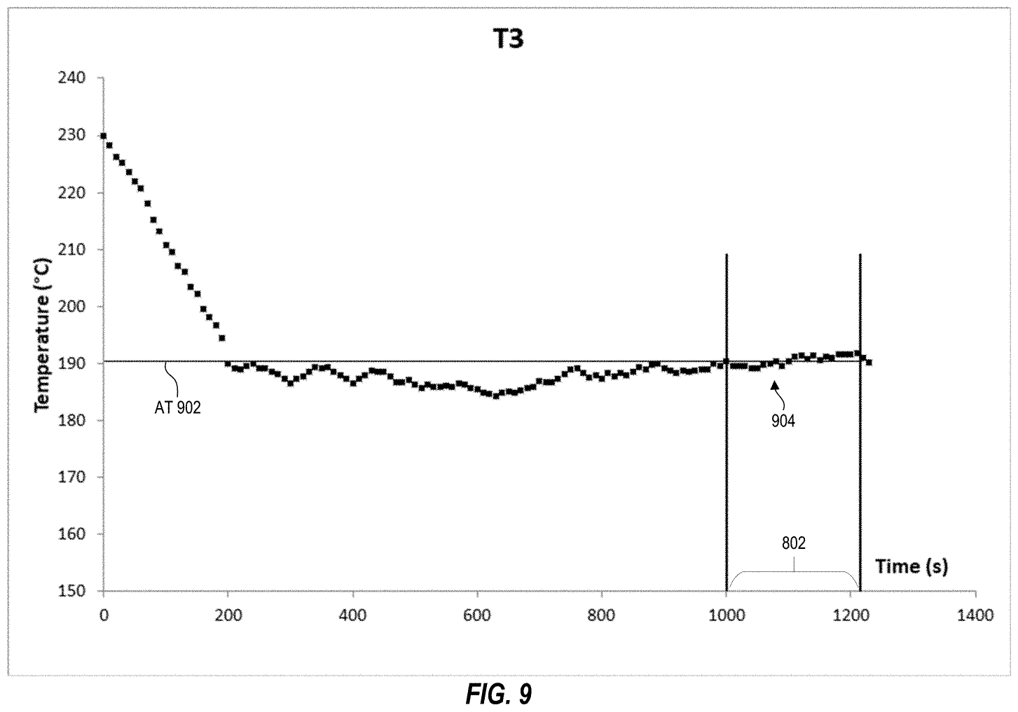

Similarly, FIG. 8 illustrates a subset 806 of temperature values T1 obtained by the first temperature sensor 130 within a temperature range 804 of 42° C. to 47° C. at timepoints within a time period 802 that is temporally subsequent to the time period 602 from FIGS. 6 and 7. FIG. 9 illustrates an ambient temperature 902 calculated based on a subset 904 of temperature values T3 obtained by the third temperature sensor 140 at timepoints within the time period 802. The system 200 may calculate yet another updated estimated cooking time using these components. In this regard, a system 200 may be configured to update estimated cooking times to account for changes in physical characteristics of a food product 220 during the cooking process.

Although the present disclosure focuses, in at least some respects, on implementations in which the intervals for updating an estimated cooking time are governed by temperature ranges (e.g., a predefined temperature steps size, such as 5° C. according to the examples of FIGS. 4-9), intervals for updating an estimated cooking time may be governed by time periods in other implementations (e.g., update estimated cooking time every 3 minutes).

Additional details will now be provided related to the estimating of a remaining time for an inner temperature sensor (e.g., first temperature sensor 130) to reach a target temperature (e.g., target temperature 218). For a small piece of uniform matter positioned within air, Newton's law of cooling provides that:

Q=hA(Tₐᵢᵣ−Tₘₐₜₜₑᵣ) (1)

where Q represents the heat that enters the matter, A represents the surface of convection, h represents the coefficient of convection, Tₘₐₜₜₑᵣ represents the temperature of the small piece of uniform matter, and Tₐᵢᵣ represents the temperature of the air. The coefficient of convection may depend on the type of cooking device being used to cook a food product. For example, in some instances, the free convection of air may be represented as about

$$10 \frac{W}{{m}^{2} K} ,$$

whereas the forced convection of air may be represented as about

$$16 \frac{W}{{m}^{2} K} .$$

Furthermore, Newton's law generally provides that:

$${C}_{p} \frac{dT}{dt} = Q \qquad ( 2 )$$

where Cₚ represents the specific heat of the matter. Combining Equation 1 with Equation 2 and solving the differential equation provides an estimation of the exponential evolution of temperature of the matter as a function of time (t):

T(t)=Tₐᵢᵣ+(T(t=0)−Tₐᵢᵣ)*e^{-hAt/C}^{ₚ} (3)

Equation 3 may be applied to estimate remaining cooking time by assuming that the core temperature (T_{core}) of a food product being cooked (e.g., food product 220 from FIG. 2) follows an exponential evolution during cooking, providing the following:

$${T}_{core} ( t ) = {T}_{air} + ( {T}_{core} ( t = 0 ) - {T}_{air} ) * exp ( \frac{h}{{C}_{p , m} ρ e} * t ) \qquad ( 4 )$$

Where C_{p,m} represents the specific heat of mass of the food product

$$( in \frac{J}{kgK} ) ,$$

ρ represents the density of the food product

$$( in \frac{g}{{m}^{3}} ) ,$$

and e represents the thickness of the food product (in m).

Applying a natural logarithm function to Equation 4 provides a linear evolution of In (Tₐᵢᵣ−T_{core}), as follows:

$$ln ( {T}_{air} - {T}_{core} ) = ln ( {T}_{air} - {T}_{core} ( t = 0 ) ) - \frac{h}{{C}_{p , m} ρ e} * t \qquad ( 5 )$$

where it is noted, as indicated hereinabove, that calorific capacity per kg (C_{p,m}) and the density (ρ) may depend on the type of food product (e.g., meat, vegetable, pastry, etc.) or the composition of the food product (e.g., water composition, fat composition, bone content, fiber composition, seed content, etc.). For example, a beef product from the United States may contain more fat than a beef product from Kobe, Japan, which may influence these parameters. Furthermore, calorific capacity per kg (C_{p,m}) and the density (ρ) may also change during the cooking of the food product (particularly for meat products) as the temperature and water, protein, and/or fat content of the food product change during the cooking process.

Rather than implementing complicated models and/or processes for measuring or determining updated values for C_{p,m} and/or ρ during the cooking process, Equation 5 may be simplified and solved for t to provide an estimation of cooking time for an inner temperature to reach a target temperature (T_{target}):

$$Cooking Time = \frac{ln ( {T}_{air} - {T}_{target} ) - b}{a} \qquad ( 6 )$$

which provides an estimated cooking time from an initial timepoint (t=0, see Equation 5) to a timepoint at which the inner temperature is estimated to reach the target temperature. Subtracting an elapsed time that has intervened between the initial timepoint (e.g., an initial timepoint of a time period 402, 602, or 802, or another reference timepoint) and a time of calculating the cooking time (e.g., a final timepoint of a time period 402, 602, or 802, or another timepoint) provides an estimated remaining time (RT) for the inner temperature to reach the target temperature, as follows:

$$RT = \frac{ln ( {T}_{air} - {T}_{target} ) - b}{a} - t \qquad ( 7 )$$

where t represents the elapsed time described above.

Thus, a system may determine an estimated remaining time for an inner temperature to reach a target temperature using an ambient temperature value (Tₐᵢᵣ), a target temperature value (T_{target}), an approximation of a slope coefficient (a), an approximation of an interception value (b), and an elapsed time value (t).

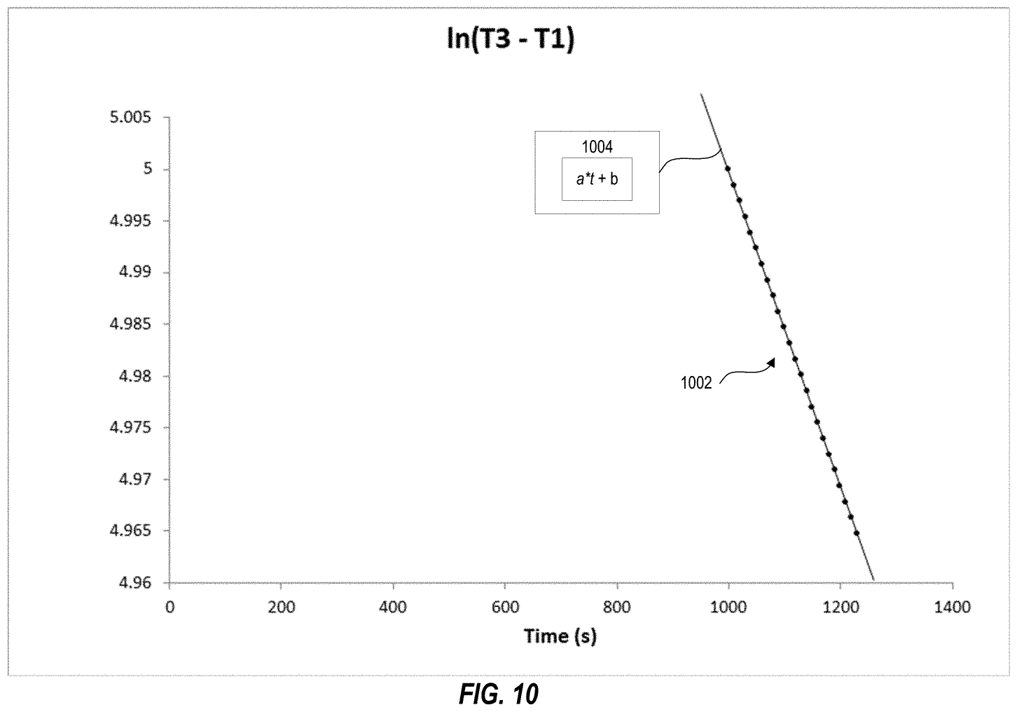

A system 200 may determine a slope coefficient a and an interception value b using inner temperature values, ambient temperature values, and timepoints associated with the inner temperature values and/or the ambient temperature values. For example, FIG. 10 illustrates an example graphical representation that includes various datapoints 1002 (illustrated as circles in the graph of FIG. 10) based on the subset 806 of temperature values T1, the timepoints of the time period 802 associated therewith, and the ambient temperature 902 from FIGS. 8 and 9. In particular, the datapoints 1002 comprise natural logarithm values of a difference between the ambient temperature 902 and the various temperature values T1 of the subset 806, which may be represented by ln (T3−T1), (which corresponds to the form of the left side of the linear equation of Equation 5 described hereinabove) where T3 comprises ambient temperature 902 and T1 comprises the various temperature values of the subset 806. The datapoints 1002 are plotted in FIG. 10 over time using the timepoints at which the various temperature values T1 of the subset 806 were obtained by the first temperature sensor 130.

The system 200 may then determine a linear regression line 1004 that models the relationship between the datapoints 1002 (i.e., In (T3−T1), as described above) and the timepoints of the time period 802 associated with the various temperature values T1 of the subset 806. Any suitable technique for generating a linear regression line 1004 is within the scope of this disclosure.

As is shown in FIG. 10, the linear regression line 1004 may be represented in the form of a linear equation, a*t+b, where a represents a slope value and b represents an interception value. As noted hereinabove, the linear equation form corresponds to the right side of Equation 5, accordingly, the slope value a of the linear regression line 1004 as demonstrated in FIG. 10 may serve as an approximation for the coefficient preceding t in the right side of Equation 5

$$( i . e . , - \frac{h}{{C}_{p , m} ρ e} ) ,$$

and the interception value b of the linear regression line 1004 as demonstrated in FIG. 10 may serve as an approximation for ln(Tₐᵢᵣ−T_{core}(t=0)) from the right side of Equation 5.

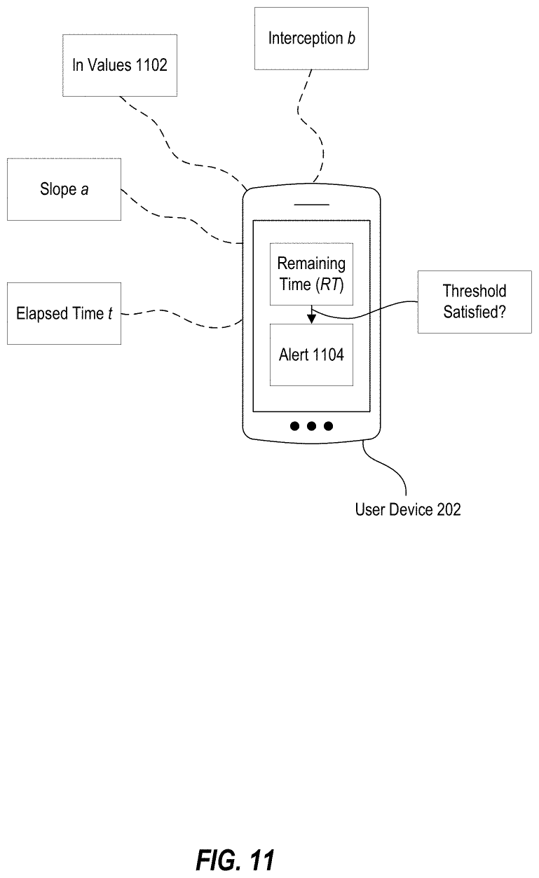

FIG. 11 illustrates that the user device 202 (and/or temperature probe 100) of the system 200 may then use the slope value a and the interception value b from the linear regression line 1004 of FIG. 10, as well as ln values 1102 and elapsed time t to determine a remaining time (RT) as shown and described with reference to Equation 7 hereinabove. For example, according to FIG. 8, the ln values 1102 may correspond to ln(Tₐᵢᵣ−T_{target}), as shown in Equation 7, and the elapsed time t may represent a time period that has intervened between the initial timepoint (e.g., an initial timepoint of time period 802) and a time of calculating the remaining time (RT). In this way, referring again to FIG. 2, a system 200 may determine the remaining time (RT) for the first temperature sensor 130 to reach the target temperature 218, and the remaining time (RT) may indicate an estimated time period before the inner core temperature of the food product 220 reaches the target temperature 218.

FIG. 11 also illustrates that, in some instances, the system 200 is configured to provide the remaining time (RT) to the user device 202, and the user device 202 may be configured to display the remaining time (RT) thereon (e.g., via I/O system(s) 214). As the system 200 updates the remaining time (RT) (e.g., as described hereinabove with reference to FIGS. 6-9), the display of the remaining time (RT) may also be updated. Furthermore, FIG. 11 shows that, in some implementations, the system 200 may be configured to communicate an alert 1104 to/on the user device 202 in response to determining that the remaining time (RT) satisfies a threshold estimated time period (e.g., 5 minutes, 3 minutes, 1 minute, or another time value). An alert 1104 may take on any suitable form, such as a visual alert and/or an audible alert. Configuring the system 200 to provide the alert 1104 when the remaining time (RT) satisfies a threshold may allow users to confidently engage in other activities during the cooking process while awaiting the alert 1104 to signal the appropriate time to adjust or end the cooking process for a food product 220.

Although the foregoing examples described above with reference to FIGS. 2-11 focus, in at least some respects, on implementations that use Equation 7 to determine the remaining time (RT), alternative implementations may utilize a modified equation to determine the remaining time (RT). For example, in some instances, a system 200 may refrain from utilizing the interception value b described above with reference to FIG. 10 as an approximation for ln(Tₐᵢᵣ−T_{core}(t=0)) and may instead calculate and use values for ln(Tₐᵢᵣ−T_{core}(t=0)), where T_{core}(t=0)) represents an initial temperature value at an initial timepoint (e.g., an initial timepoint of a time period 402, 602, or 802, or another reference timepoint) as follows:

$$RT = \frac{ln ( {T}_{air} - {T}_{target} ) - ln ( {T}_{air} - {T}_{core} ( t = 0 ) )}{a} - t \qquad ( 8 )$$

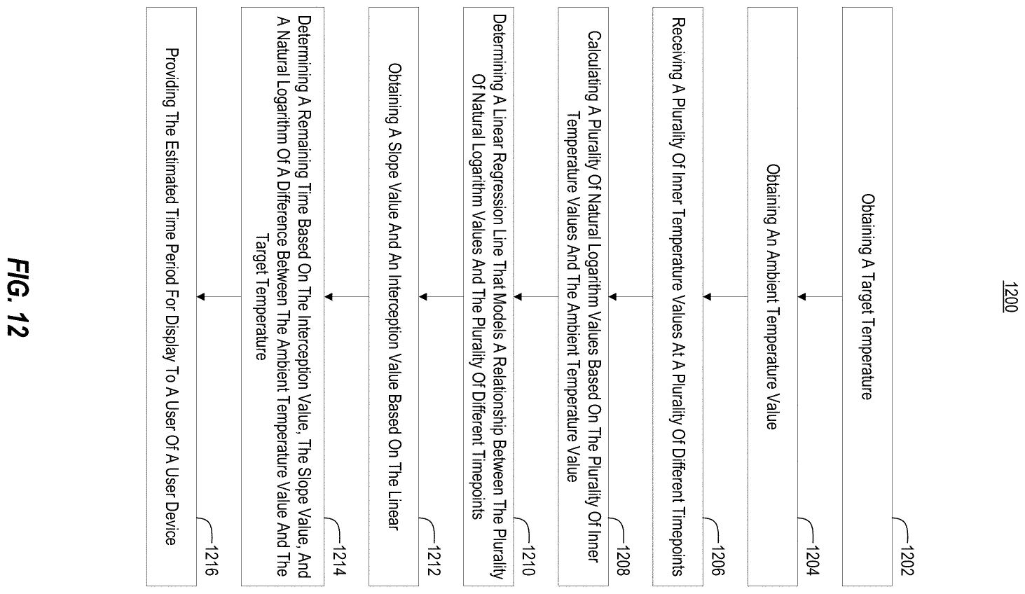

Some implementations of the present disclosure can also be described in terms of acts (e.g., acts of a method) for accomplishing a particular result. Along these lines, FIG. 12 illustrates an example flow diagram 1200 depicting a method for estimating an amount of time remaining for a temperature sensor to reach a target temperature. Although the acts shown in flow diagram 1200 may be illustrated and/or discussed in a certain order, no particular ordering is required unless specifically stated or required because an act is dependent on another act being completed prior to the act being performed. Furthermore, it should be noted that not all acts represented in the flow diagrams are essential for estimating an amount of time remaining for a temperature sensor to reach a target temperature.

In some instances, the acts of the flow diagrams are described below with reference to the systems, components, structures, and/or elements of FIGS. 1A-11. For instance, at least some reference numerals included parenthetically hereinbelow refer, by way of illustrative example, to systems, components, structures, and/or elements described hereinabove with reference to FIGS. 1A-11.

Act 1202 of flow diagram 1200 includes obtaining a target temperature (218). In some implementations, obtaining a target temperature (218) includes receiving user input (216) indicating a type of food product (220) and a desired doneness of the food product (220). Obtaining the target temperature (218) may furthermore include identifying the target temperature (218) from a data structure (from data 212) based on the user input (216).

Act 1204 of flow diagram 1200 includes obtaining an ambient temperature value (902). In some implementations, obtaining the ambient temperature value (902) includes wirelessly receiving temperature data from an ambient temperature sensor (140) while the ambient temperature sensor (140) is positioned to sense temperature of a cooking environment (224) surrounding the food product (220).

In some instances, obtaining the ambient temperature value (902) includes receiving a plurality of ambient temperature readings (904) based on temperature data (T3) obtained by the ambient temperature sensor (140) at a plurality of different timepoints (within 802) and calculating an average of the plurality of ambient temperature readings (904).

Act 1206 of flow diagram 1200 includes receiving a plurality of inner temperature values (806) at a plurality of different timepoints (within 802). In some implementations, the plurality of inner temperature values are obtained by a relevant inner temperature sensor (130). The inner temperature values (806) may be based on temperature data (T1) wirelessly received from the relevant inner temperature sensor (130) while the relevant inner temperature sensor (130) is positioned to sense temperature within an interior of a food product (220).

In some instances, the relevant temperature sensor (130) is designated as such by receiving temperature data from a plurality of inner temperature sensors (130, 134) and, in response to detecting a triggering condition, defining a particular temperature sensor of the plurality of inner temperature sensors (130, 134) that is associated with a lowest temperature reading as the relevant inner temperature sensor (130). In some implementations, the triggering condition includes determining that each inner temperature sensor (130, 134) of the plurality of inner temperature sensors (130, 134) is associated with a temperature reading that satisfies a predetermined threshold temperature reading.

Furthermore, the plurality of inner temperature values (806) may comprise temperature values between an initial inner temperature value and a final inner temperature value (e.g., defining temperature range 804), where a difference between the initial inner temperature value and the final inner temperature value comprises a predefined temperature difference (804).

Act 1208 of flow diagram 1200 includes calculating a plurality of natural logarithm values (1002) based on the plurality of inner temperature values (806) and the ambient temperature value (902). The plurality of natural logarithm values (1002) may include, for each particular inner temperature value of the plurality of inner temperature values (806), a natural logarithm of a difference between the ambient temperature value (902) and the particular inner temperature value (806).

Act 1210 of flow diagram 1200 includes determining a linear regression line (1004) that models a relationship between the plurality of natural logarithm values (1002) and the plurality of different timepoints (e.g., within 802). Act 1212 of flow diagram 1200 includes obtaining a slope value (a) and an interception value (b) based on the linear regression line (1004). Any suitable technique for determining a linear regression line (1004) is within the scope of this disclosure.

Act 1214 of flow diagram 1200 includes determining a remaining time (RT) based on the interception value (b), the slope value (a), and a natural logarithm of a difference between the ambient temperature value (902) and the target temperature (218). In some instances, the remaining time is further based on an elapsed heating time (t). The remaining time (RT) may be calculated according to various approaches, such as by utilizing Equation 7 described hereinabove, or Equation 8. In some instances, the remaining time (RT) indicates estimated time period for an inner temperature (T1) of the relevant inner temperature sensor (130) to reach the target temperature (218).

Act 1216 of flow diagram 1200 includes providing the estimated time period (RT) for display to a user of a user device (202). In some implementations, the user device (202) or another system is configured, in response to determining that the estimated time period (RT) satisfies a threshold estimated time period, to communicate an alert for presentation to a user of the user device (202).

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system.

Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media (e.g., hardware storage devices) and transmission computer-readable media.

Physical computer-readable storage media includes hardware storage devices such as RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g. as separate threads).

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, devices, products, kits, methods, and/or processes, according to certain embodiments of the present disclosure may include, incorporate, or otherwise comprise properties, features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A temperature probe, comprising:
a shaft extending between a distal tip and a proximal end thereof, the shaft comprising a lateral sidewall forming a cavity within the shaft between the distal tip and the proximal end;
a first temperature sensor positioned within the cavity and configured to sense a temperature associated with the distal tip of the shaft;
a second temperature sensor positioned within the cavity and configured to sense a temperature associated with a middle portion of the shaft between the distal tip and the proximal end; and
a ceramic cap configured to fit over the proximal end of the shaft, the ceramic cap comprising a third temperature sensor configured to sense a temperature associated with an environment surrounding the ceramic cap.

2. The temperature probe of claim 1, wherein the distal tip is shaped for penetrating a food product to facilitate positioning of the shaft within an interior of the food product to arrange the first temperature sensor and the second temperature sensor to sense an internal temperature of the food product.

3. The temperature probe of claim 1, further comprising:
thermal paste forming a thermally conductive path between an interior portion of the distal tip and the first temperature sensor; and
a thermal pad forming a thermally conductive path between an interior portion of the middle portion of the shaft and the second temperature sensor.

4. The temperature probe of claim 1, wherein the ceramic cap is configured to secure over the proximal end of the shaft via a friction fit.

5. The temperature probe of claim 4, further comprising a silicone stopper positioned within the cavity of the shaft at the proximal end of the shaft to insulate an interior of the shaft.

6. The temperature probe of claim 1, wherein the second temperature sensor is arranged within the cavity of the shaft between a battery disposed within the cavity and the proximal end of the shaft.

7. The temperature probe of claim 1, further comprising:
a printed circuit board (PCB) disposed within the cavity of the shaft;
a battery disposed within the cavity of the shaft between the PCB and the distal tip of the shaft;
a flex PCB element connecting the first temperature sensor to the PCB, the flex PCB element extending between the battery and the lateral sidewall forming the cavity within the shaft, the flex PCB element comprising a thickness of about 0.25 mm or less.

8. The temperature probe of claim 1, further comprising a wireless transmitter configured to emit signals communicating temperature values sensed by the first temperature sensor, the second temperature sensor, and the third temperature sensor.

9. A system configured for estimating an amount of time remaining for a temperature sensor to reach a target temperature, comprising:
a temperature probe, comprising:
a shaft extending between a distal tip and a proximal end thereof, the shaft comprising a lateral sidewall forming a cavity within the shaft between the distal tip and the proximal end;
a first temperature sensor positioned within the cavity and configured to sense a temperature associated with the distal tip of the shaft;
a second temperature sensor positioned within the cavity and configured to sense a temperature associated with a middle portion of the shaft between the distal tip and the proximal end; and
an insulating cap configured to fit over the proximal end of the shaft, the insulating cap comprising a third temperature sensor configured to sense a temperature associated with an environment surrounding the insulating cap; and
a computer system, comprising:
one or more processors, and
one or more hardware storage devices storing computer-executable instructions that are operable, when executed by the one or more processors, to configure the computer system to:
obtain a target temperature;
receive an ambient temperature value based on temperature data obtained by the third temperature sensor;
receive a first plurality of inner temperature values based on temperature data obtained by the first temperature sensor;
receive a second plurality of inner temperature values based on temperature data obtained by the second temperature sensor;
define the first temperature sensor or the second temperature sensor as a relevant inner temperature sensor; and
determine a remaining time indicating an estimated time period for an inner temperature of the relevant inner temperature sensor to reach the target temperature;

10. The system of claim 9, wherein obtaining the target temperature comprises:
receiving user input indicating a type of food product and a desired doneness of the food product; and
identifying the target temperature from a data structure based on the user input.

11. The system of claim 9, wherein receiving the ambient temperature value comprises:
receiving a plurality of ambient temperature readings based on temperature data obtained by the third temperature sensor at a plurality of different timepoints; and
calculating an average of the plurality of ambient temperature readings.

12. The system of claim 9, wherein the computer-executable instructions are further operable to configure the computer system to obtain a plurality of relevant inner temperature values from the relevant inner temperature sensor, wherein the plurality of relevant inner temperature values comprises temperature values between an initial inner temperature value and a final inner temperature value, wherein a difference between the initial inner temperature value and the final inner temperature value comprises a predefined temperature difference.

13. The system of claim 9, wherein the computer system is configurable to wirelessly receive the first plurality of inner temperature values or the second plurality of inner temperature while the first temperature sensor or the second temperature sensor is/are positioned to sense temperature within an interior of a food product.

14. The system of claim 9, wherein defining the first temperature sensor or the second temperature sensor as the relevant inner temperature sensor comprises:
detecting a triggering condition;
in response to detecting the triggering condition, identifying whether the first temperature sensor or the second temperature sensor provides a lower inner temperature reading; and
defining the first temperature sensor as the relevant inner temperature sensor if the first temperature sensor provides the lower inner temperature reading, or, alternatively, defining the second temperature sensor as the relevant inner temperature sensor if the second temperature sensor provides the lower inner temperature reading.

15. The system of claim 14, wherein the triggering condition comprises determining that temperature values provided by the first temperature sensor and temperature values provided by the second temperature sensor satisfy a predetermined threshold temperature reading.

16. The system of claim 9, wherein the computer-executable instructions are further operable to configure the computer system to:
provide the estimated time period for display to a user of a user device.

17. A method for estimating an amount of time remaining for a temperature sensor to reach a target temperature, comprising:
obtaining a target temperature;
obtaining an ambient temperature value based on temperature data obtained by an ambient temperature sensor;
receiving a plurality of inner temperature values based on temperature data obtained by a relevant inner temperature sensor at a plurality of different timepoints;
calculating a plurality of natural logarithm values comprising, for each particular inner temperature value of the plurality of inner temperature values, a natural logarithm of a difference between the ambient temperature value and the particular inner temperature value;
determining a linear regression line that models a relationship between the plurality of natural logarithm values and the plurality of different timepoints;
obtaining a slope value and an interception value based on the linear regression line; and
determining a remaining time indicating an estimated time period for an inner temperature of the relevant inner temperature sensor to reach the target temperature, the remaining time being based on a natural logarithm of a difference between the ambient temperature value and the target temperature, the interception value, and the slope value.

18. The method of claim 17, wherein:
the method further comprises obtaining thermodynamic parameters associated with a food product from a local or remote database; and
the remaining time is further based on the thermodynamic parameters associated with the food product.

19. The method of claim 17, wherein the plurality of inner temperature values indicates a predefined temperature increase between an initial inner temperature value and a final inner temperature value.

20. The method of claim 17, further comprising:
receive temperature data from a plurality of inner temperature sensors; and
in response to detecting a triggering condition, defining a particular temperature sensor of the plurality of inner temperature sensors that is associated with a lowest temperature reading as the relevant inner temperature sensor.
